(19) United States
(12) Patent Application Publication
(10) Pub. No.: US 2005/0271218 A1
(43) Pub. Date: Dec. 8, 2005

(54) Palm type dolby decoding earphone device

(76) Inventor: Tseng-Tien Peng, Taipei Hsien (TW)

Correspondence Address: Tseng-Tien Peng, 235 Chung-Ho, P.O. BOX 10-69, Taipei, TW

(21) Appl. No.: 10/862,129

(22) Filed: Jun. 7, 2004

(51) Int. Cl. H04R 1/10

(52) U.S. Cl. 381/74; 381/374

(57) ABSTRACT

A palm type Dolby decoding earphone device comprises a Dolby decoder device having a sound effect input end; a sound effect output end; the sound effect input end having a digital optical fiber signal wire and an optical fiber input joint for connecting an external electronic device so that the sound effect input end can receive external digital sound signals; the Dolby decoder device serves to generate Dolby surrounding sound effect by the phase differences of the digital sound signals; at least one earphone set being connected to the sound effect output end for receiving the decoded sound signals from the control unit; each earphone set having two earphones for transmitting sound signals to the two ears of a user.

### FIELD OF THE INVENTION

The present invention relates to Dolby decoders, and particularly to a palm type Dolby decoding earphone device, which is portable and not to be confined by environment. Moreover, the palm type Dolby decoding earphone device has the sound quality of home theatres, but not to interfere other people. The palm type Dolby decoding earphone device of the present invention will not confine by the space.

### BACKGROUND OF THE INVENTION

In the conventional home theatre, a DVD drive is connected to a player with a Dolby decoder so that sound can be transferred to different speakers with multiple channels so as to generate a surrounding sound effect. However the prior art has the following drawbacks. Firstly, the conventional home theatre is a fixed type machine. Thereby it only uses in a fixed place. The Dolby sound effect cannot be presented at any desired place. Furthermore, in use of the home theatre, the large sound effect will interfere other peoples nearby and thus the use of the prior art is limited. Moreover, since it is often that a larger space is necessary, but it cannot be achieved by anyone. Moreover, the installation of the prior art needs much time and works and the assembly of the prior art is by wire connection so that the wiring and arrangement work needs much time.

### SUMMARY OF THE INVENTION

Accordingly, the main object of the object is to provides a palm type Dolby decoding earphone device, wherein the palm type Dolby decoding earphone device of the present invention is portable without environmental limitation.

Moreover, the palm type Dolby decoding earphone device has the sound quality of home theatre, but not to interfere other people. The palm type Dolby decoding earphone device of the present invention will not confine by the space.

Furthermore, only one optical fiber is used to combine the optical joint of a DVD drive. The palm type Dolby decoding earphone device of the present invention presents Dolby surrounding sound effect with simple wiring and arrangement work and without confining by space.

Further, the palm type Dolby decoding earphone device of the present invention can be assembled quickly and used easily and conveniently, which can be used in plane, or car, and in traveling.

The present invention provides a palm type Dolby decoding earphone device which comprises a Dolby decoder device having a sound effect input end; a sound effect output end; the sound effect input end has a digital optical fiber signal wire and an optical fiber input joint for connecting an external electronic device (such as a DVD drive, a CD drive, an MP3 player, a TV, a tuner, a VCD driver, a stereo, a computer, etc.) so that the sound effect input end can receives external digital sound signals; the Dolby decoder device serves to generate Dolby surrounding sound effect by the phase differences of the digital sound signals; at least one earphone set being connected to the sound effect output end for receiving the decoded sound signals from the control unit; each earphone set having two earphones for transmitting sound signals to the two ears of a user.

The various objects and advantages of the present invention will be more readily understood from the following detailed description when read in conjunction with the appended drawing.

### BRIEF DESCRIPTION OF THE DRAWINGS

FIG. 1 shows the first embodiment of the palm type Dolby decoding earphone device of the present invention.

FIG. 1-1 shows the second embodiment of the palm type Dolby decoding earphone device of the present invention.

FIG. 2 shows the third embodiment of the palm type Dolby decoding earphone device of the present invention.

FIG. 3 shows the fourth embodiment of the palm type Dolby decoding earphone device of the present invention.

FIG. 4 shows the fifth embodiment of the palm type Dolby decoding earphone device of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

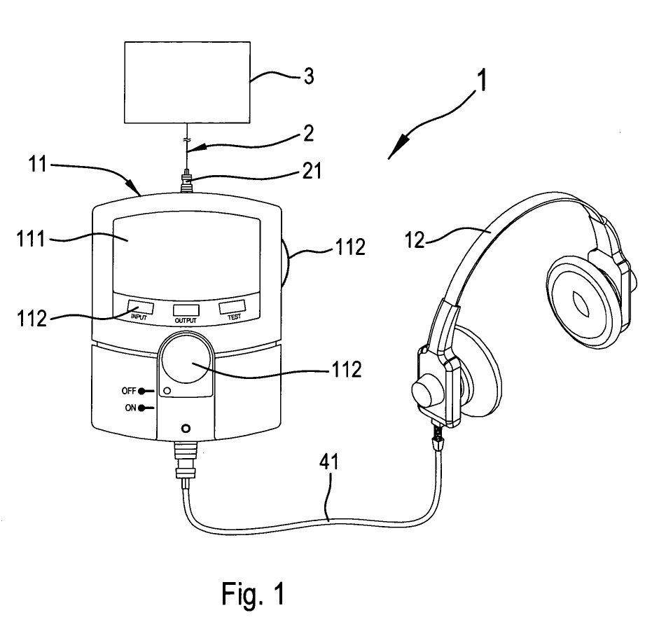

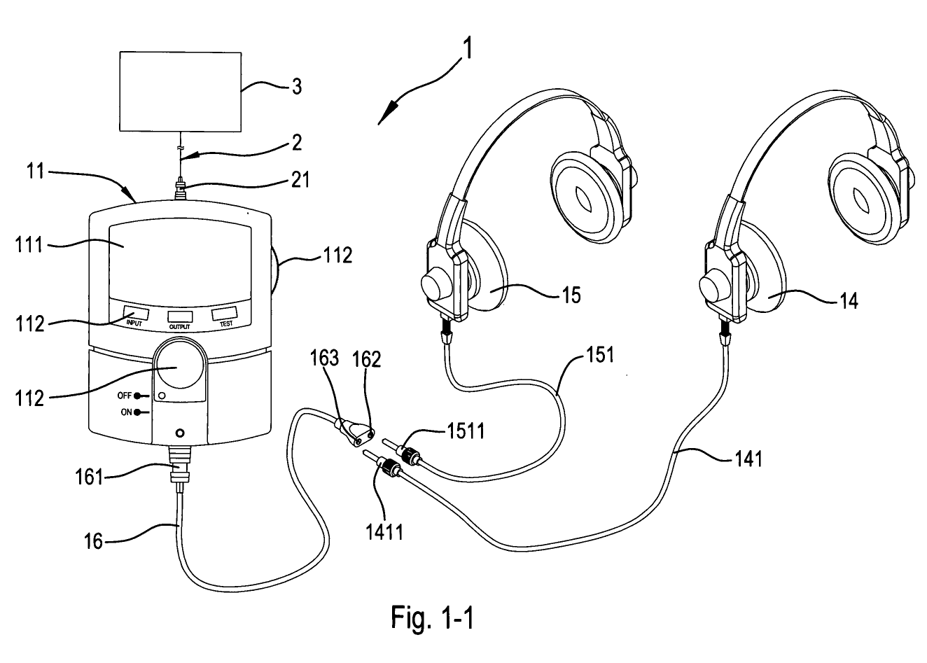

With reference to FIG. 1, the first embodiment of the palm type Dolby decoding earphone device according to the present invention is illustrated. The palm type Dolby decoding earphone device 1 of the present invention comprises the following elements.

A Dolby decoder device 11 has a sound effect input end; a sound effect output end; a control panel 111, and a control unit 112.

The sound effect input end has a digital optical fiber signal wire 2 and an optical fiber input joint 21 for connecting an external electronic device 3 (such as a DVD drive, a CD drive, an MP3 player, a TV, a tuner, a VCD driver, a stereo, a computer, etc.) for receiving external digital sound signals. The Dolby decoder device 11 serves to generate Dolby surrounding sound effect by the phase differences of the digital sound signals.

The control panel 111 and control unit 112 serve to make the listener to understand current operation status and to adjust the volume.

An earphone set 12 is connected to the sound effect output end of the Dolby decoder device 11 and is connected to the control unit 112 through an earphone wire 41 for receiving the decoded sound signals from the Dolby decoder device 11. Each earphone set has two earphones for transmitting sound signals to the two ears of a user.

In the present invention, the volume of the Dolby decoder device 11 is decremented so that the user can carry it easily. Thereby the Dolby decoder device 11 can be used in various environments. Thereby the sound is played through the earphone set 12 so as not to interfere other persons.

For example, sound from a DVD player is inputted to the digital optical fiber signal wire 2 through an optical fiber so that the sound can be heard as the user is within a car or a plane.

Referring to FIG. 1-1, the second embodiment of the palm type Dolby decoding earphone device 1 of the present invention is illustrated. The Dolby decoder device 11 of the present invention has the following elements.

A Dolby decoder device 11 has a sound effect input end; a sound effect output end; a control panel 111, and a control unit 112.

The sound effect input end has a digital optical fiber signal wire 2 and an optical fiber input joint 21 for connecting an external electronic device 3 for receiving external digital sound signals. The Dolby decoder device 11 serves to generate Dolby surrounding sound effect by the phase differences of the digital sound signals.

The control panel 111 and control unit 112 serve to make the listener to understand current operation status and to adjust the volume.

A sound effect stub 16 extending from the Dolby decoder device 11 has an input end 161 which is connected to two output ends 162, 163 of the sound effect stub 16.

Two plug-in earphones sets 14, 15 are connected to the sound effect output end of the Dolby decoder device 11 and have respective earphone wires 141, 151. The earphone wires 141, 151 have respective earphone plugs 1411, 1511 which can be inserted into the respective two output ends 162, 163 of the sound effect stub 16 so as to transfer sound signals to the plug-in earphones.

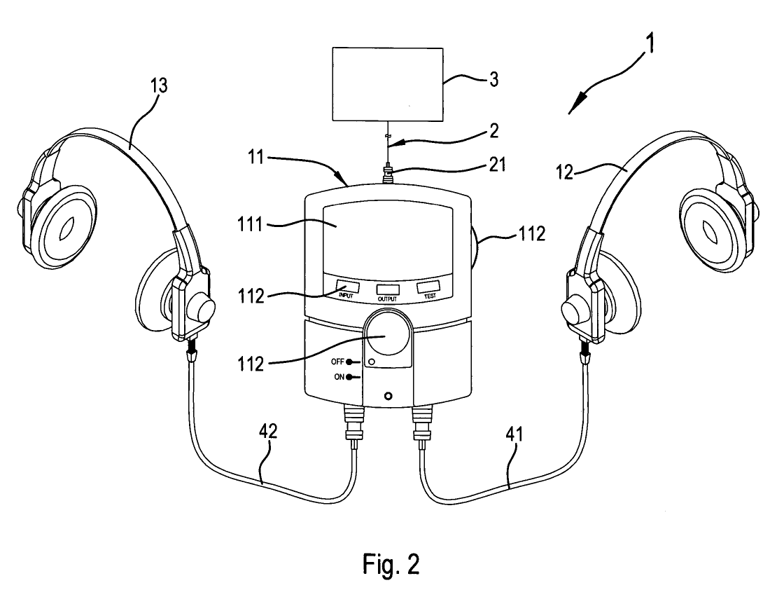

With reference to FIG. 2, the third embodiment of the palm type Dolby decoding earphone device 1 of the present invention is illustrated. The Dolby decoder device 11 of the present invention has the following elements.

A Dolby decoder device 11 has a sound effect input end; a sound effect output end; a control panel 111, and a control unit 112.

The sound effect input end has a digital optical fiber signal wire 2 and an optical fiber input joint 21 for connecting an external electronic device 3 for receiving external digital sound signals. The Dolby decoder device 11 serves to generate Dolby surrounding sound effect by the phase differences of the digital sound signals.

The control panel 111 and control unit 112 serve to make the listener to understand current operation status and to adjust the volume.

Two plug-in earphone sets 12, 13 are connected to the sound effect output end of the Dolby decoder device 11 and have respective earphone wires 41, 42. Each earphone set has two earphones for transmitting sound signals to the two ears of a user.

In the present invention, a volume of the Dolby decoder device 11 is decremented so that the user can carry it easily. Thereby the Dolby decoder device 11 can be used in various environments. Thereby the sound is played through the earphone sets 12, 13 so as not to interfere other persons.

For example, sound from a game machine is inputted to the Dolby decoder device through an optical fiber so that the sound can be heard.

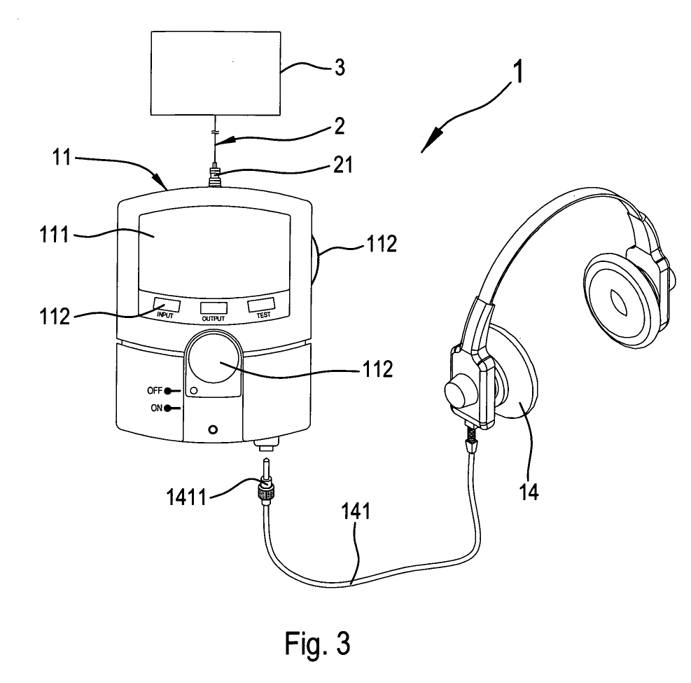

With reference to FIG. 3, the fourth embodiment of the palm type Dolby decoding earphone device 1 of the present invention is illustrated. The Dolby decoder device 11 of the present invention has the following elements.

A Dolby decoder device 11 has a sound effect input end; a sound effect output end; a control panel 111, and a control unit 112.

The sound effect input end has a digital optical fiber signal wire 2 and an optical fiber input joint 21 for connecting an external electronic device 3 for receiving external digital sound signals. The Dolby decoder device 11 serves to generate Dolby surrounding sound effect by the phase differences of the digital sound signals.

The control panel 111 and control unit 112 serve to make the listener to understand current operation status and to adjust the volume.

A plug-in earphone set 14 is connected to the sound effect output end of the Dolby decoder device 11 and has an earphone wire 141. One end of the earphone wire 141 has a plug 1411. By the plug 1411, the plug-in earphone set 14 can be connected to the control unit 112.

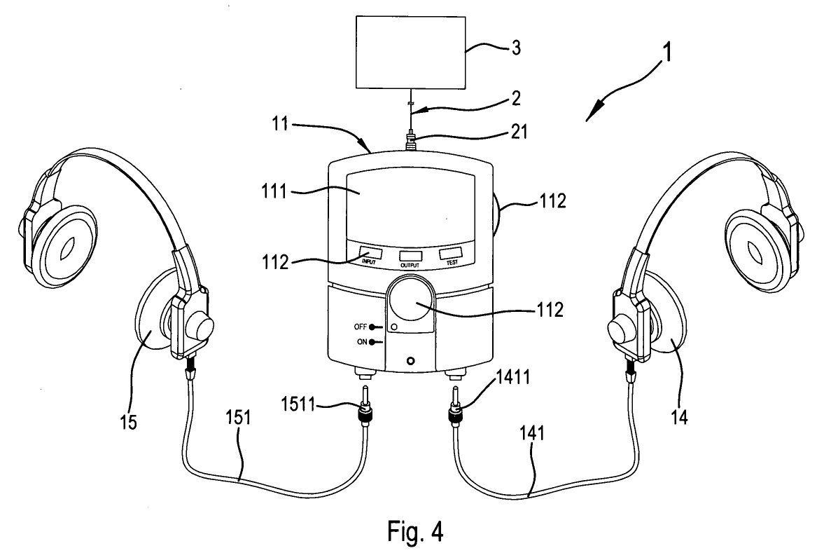

With reference to FIG. 4, the fifth embodiment of the palm type Dolby decoding earphone device 1 of the present invention is illustrated. The Dolby decoder device 11 of the present invention has the following elements.

A Dolby decoder device 11 has a sound effect input end; a sound effect output end; a control panel 111, and a control unit 112.

The sound effect input end has a digital optical fiber signal wire 2 and an optical fiber input joint 21 for connecting an external electronic device 3 for receiving external digital sound signals. The Dolby decoder device 11 serves to generate Dolby surrounding sound effect by the phase differences of the digital sound signals.

The control panel 111 and control unit 112 serve to make the listener to understand current operation status and to adjust the volume.

Two plug-in earphone sets 14, 15 are connected to the sound effect output end of the Dolby decoder device 11 and have respective earphone wires 141, 151. One end of each earphone wire 141, 151 has a plug 1411, 1511. By the plug 1411, 1511, the plug-in earphone set 14, 15 can be connected to the control unit 112.

Advantages of the present invention will be described herein. The palm type Dolby decoding earphone device of the present invention is portable without environmental limitation. The palm type Dolby decoding earphone device has the sound quality of home theatre, but not to interfere other people. The palm type Dolby decoding earphone device of the present invention will not confine by the space. Only one optical fiber is used to combine the optical joint of a DVD drive. The palm type Dolby decoding earphone device of the present invention presents Dolby surrounding sound effect without the expense of wiring and arrangement and without confining by space. The palm type Dolby decoding earphone device of the present invention can be assembled quickly and used easily and conveniently, which can be used in plane, car, and in traveling.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A palm type Dolby decoding earphone device comprising:
a Dolby decoder device having a sound effect input end; a sound effect output end; the sound effect input end having a digital optical fiber signal wire and an optical fiber input joint for connecting an external electronic device so that the sound effect input end can receive external digital sound signals; the Dolby decoder device serves to generate Dolby surrounding sound effect by the phase differences of the digital sound signals;
at least one earphone set being connected to the sound effect output end for receiving the decoded sound signals from the control unit; each earphone set having two earphones for transmitting sound signals to the two ears of a user.

2. The palm type Dolby decoding earphone device as claimed in claim 1, wherein the at least one earphone set is fixed to the sound effect output end.

3. The palm type Dolby decoding earphone device as claimed in claim 1, wherein the at least one earphone set is a plug-in earphone set which can be separated from the sound effect output end.

4. The palm type Dolby decoding earphone device as claimed in claim 1, wherein the sound effect output end is connected to a sound effect stub so as to be connected to more than one earphone set.

5. The palm type Dolby decoding earphone device as claimed in claim 1, wherein at least two earphone sets are fixedly connected to the sound effect output end.

6. The palm type Dolby decoding earphone device as claimed in claim 1, wherein the Dolby decoder device has a control panel, and a control unit by that the user can understand the statue of the Dolby decoder device and control the volume of output sounds.

7. The palm type Dolby decoding earphone device as claimed in claim 1, wherein the control unit is one of a button and a key.

8. The palm type Dolby decoding earphone device as claimed in claim 1, wherein the electronic device is one of s a DVD drive, a CD drive, an MP3 player, a TV, a tuner, a VCD driver, a stereo, and a computer.
